(19) United States
(12) Patent Application Publication
(10) Pub. No.: US 2008/0291323 A1
(43) Pub. Date: Nov. 27, 2008

(54) Image processing device, data recording device, and method of controlling image processing device

(75) Inventors: Chisato Higuchi, Fuchu-shi (JP); Takeshi Makabe, Tama-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/153,134

(22) Filed: May 14, 2008

(30) Foreign Application Priority Data
May 22, 2007 (JP) 2007-135786
May 22, 2007 (JP) 2007-135787

(51) Int. Cl. H04N 7/01

(52) U.S. Cl. 348/448; 348/E07.002

(57) ABSTRACT

The interlace/progressive conversion section of an image processing device sequentially receives image data corresponding to odd-numbered lines or sequentially receives image data corresponding to even-numbered lines. The interlace/progressive conversion section performs an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines. After the even-numbered-line interpolation process, the interlace/progressive conversion section generates a progressive image by using image data corresponding to odd-numbered lines and image data corresponding to even-numbered lines generated by the even-numbered-line interpolation process; and after the odd-numbered-line interpolation process, the interlace/progressive conversion section generates a progressive image by using image data corresponding to even-numbered lines and image data corresponding to odd-numbered lines generated by the odd-numbered-line interpolation process.

Japanese Patent Application No. 2007-135786, filed on May 22, 2007, and Japanese Patent Application No. 2007-135787, filed on May 22, 2007, are hereby incorporated by reference in their entirety.

### BACKGROUND OF THE INVENTION

The present invention relates to an image processing device, a data recording device, and a method of controlling an image processing device.

When investigating a car accident, the testimony of an eyewitness and various pieces of physical evidence are required. However, when nobody witnessed the accident or physical evidence is insufficient, the investigator mainly relies on the memory of the person concerned so that inaccuracy inevitably occurs. An accident may occur when a car travels at high speed. In this case, the person concerned may not remember the scene. Moreover, each person concerned may testify in his favor. As a means that solves such a problem, a drive recorder has been known which is provided in a moving body (e.g., car) in order to acquire image data at the time of an accident (see JP-A-5-197858).

However, since a drive recorder generally records image data taken with one camera, a valid image cannot be acquired when the cause of an accident is located in a direction differing from the photographing direction of the camera.

### SUMMARY

According to a first aspect of the invention, there is provided an image processing device having an interlace/progressive conversion section that receives interlaced image data and converts the interlaced image data into progressive image data,

the interlace/progressive conversion section sequentially receiving image data corresponding to odd-numbered lines or sequentially receiving image data corresponding to even-numbered lines,

the interlace/progressive conversion section performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;

after the even-numbered-line interpolation process, the interlace/progressive conversion section generating a progressive image by using image data corresponding to odd-numbered lines and image data corresponding to even-numbered lines generated by the even-numbered-line interpolation process; and

after the odd-numbered-line interpolation process, the interlace/progressive conversion section generating a progressive image by using image data corresponding to even-numbered lines and image data corresponding to odd-numbered lines generated by the odd-numbered-line interpolation process.

According to a second aspect of the invention, there is provided an image processing device having an interlace/progressive conversion section that receives interlaced image data and converts the interlaced image data into progressive image data, the image processing device comprising:

a conversion mode setting register in which mode information relating to a conversion format is set,

the interlace/progressive conversion section including a normal mode conversion section and an interpolation mode conversion section;

when a value indicating a first mode is stored in the conversion mode setting register, the normal mode conversion section storing interlaced image data corresponding to odd-numbered lines and interlaced image data corresponding to even-numbered lines received before or after the interlaced image data corresponding to the odd-numbered lines in an image data buffer, and generating a progressive image by using the image data corresponding to the odd-numbered lines or the image data corresponding to the even-numbered lines that is stored in the image data buffer and corresponds to a line number of an image to be output;

when a value indicating a second mode is stored in the conversion mode setting register, the interpolation mode conversion section sequentially receiving image data corresponding to odd-numbered lines or sequentially receiving image data corresponding to even-numbered lines,

the interpolation mode conversion section performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;

after the even-numbered-line interpolation process, the interlace/progressive conversion section generating a progressive image by using image data corresponding to the odd-numbered lines and image data corresponding to the even-numbered lines generated by the even-numbered-line interpolation process; and

after the odd-numbered-line interpolation process, the interlace/progressive conversion section generating a progressive image by using image data corresponding to the even-numbered lines and image data corresponding to the odd-numbered lines generated by the odd-numbered-line interpolation process.

According to a third aspect of the invention, there is provided an image processing device that receives interlaced image data and converts the interlaced image data into progressive image data, the image processing device comprising:

a conversion mode setting register in which mode information relating to a conversion format is set;

a normal mode conversion section, when a value indicating a first mode is stored in the conversion mode setting register, the normal mode conversion section storing interlaced image data corresponding to odd-numbered lines and interlaced image data corresponding to even-numbered lines received before or after the image data corresponding to the odd-numbered lines in an image data buffer, and generating a progressive image by using the image data corresponding to the odd-numbered lines or the image data corresponding to the even-numbered lines that is stored in the image data buffer and corresponds to a line number of an image to be output; and

a single-field mode conversion section, when a value indicating a second mode is stored in the conversion mode setting register, the single-field mode conversion section generating a progressive image by doubling the image data corresponding to the even-numbered lines or the image data corresponding to the odd-numbered lines.

According to a fourth aspect of the invention, there is provided a method of controlling an image processing device having an interlace/progressive conversion section that receives interlaced image data and converts the interlaced image data into progressive image data, the method comprising:

sequentially receiving image data corresponding to odd-numbered lines or sequentially receiving image data corresponding to even-numbered lines;

performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;

after the even-numbered-line interpolation process, generating a progressive image by using image data corresponding to odd-numbered lines and image data corresponding to even-numbered lines generated by the even-numbered-line interpolation process; and

after the odd-n-umbered-line interpolation process, generating a progressive image by using image data corresponding to even-numbered lines and image data corresponding to odd-numbered lines generated by the odd-numbered-line interpolation process.

According to a fifth aspect of the invention, there is provided an image processing device having image data input terminals respectively provided for a plurality of input channels and an image data output terminal provided for at least one output channel, the image processing device comprising:

an input channel change control section that changes an output target input channel at a predetermined timing; and

an image data selection output section that receives image data corresponding to a first input channel up to image data corresponding to an nth input channel (n is an integer) from the image data input terminals in a predetermined cycle, and selects and outputs the image data from one of the image data input terminals corresponding to the output target input channel.

According to a sixth aspect of the invention, there is provided an image processing device having image data input terminals respectively provided for a plurality of input channels and an image data output terminal provided for at least one output channel, the image processing device comprising:

an output mode setting register in which mode information relating to an output format is set;

an auto scan output section, when a value indicating a zeroth mode is stored in the output mode setting register, the auto scan output section performing an auto scan output process that sequentially changes an output target input channel and selects and outputs image data corresponding to the output target input channel from image data corresponding to the input channels; and

a fixed channel output section, when a value indicating a first mode is stored in the output mode setting register, the fixed channel output section performing a fixed channel output process that outputs image data corresponding to a fixed input channel without changing the output target input channel.

According to a seventh aspect of the invention, there is provided a data recording device comprising:

any of the above-described image processing devices, image data from a plurality of imaging sections being input to the image processing device through image data input terminals respectively provided for a plurality of input channels;

a write section that writes an output from the image processing device into a first storage section;

an image data record event detection section that detects whether or not a predetermined image data record event has occurred; and

a write section that reads image data stored in the first storage section and writes the read image data into a nonvolatile second storage section when occurrence of the predetermined image data record event has been detected.

According to an eighth aspect of the invention, there is provided a method of controlling an image processing device having image data input terminals respectively provided for a plurality of input channels and an image data output terminal provided for at least one output channel, the method comprising:

changing an output target input channel at a predetermined timing; and

receiving image data corresponding to a first input channel up to image data corresponding to an nth input channel (n is an integer) from the image data input terminals in a predetermined cycle, selecting and outputting the image data from one of the image data input terminals corresponding to the output target input channel.

According to a ninth aspect of the invention, there is provided a method of controlling an image processing device having image data input terminals respectively provided for a plurality of input channels and an image data output terminal provided for at least one output channel, the method comprising:

setting mode information relating to an output format in an output mode setting register;

when a value indicating a zeroth mode is stored in the output mode setting register, performing an auto scan output process that sequentially changes an output target input channel and selects and outputs image data corresponding to the output target input channel from image data corresponding to the input channels; and

when a value indicating a first mode is stored in the output mode setting register, performing a fixed channel output process that outputs image data corresponding to a fixed input channel without changing the output target input channel.

### BRIEF DESCRIPTION OF THE SEVERAL VIEWS OF THE DRAWING

FIG. 1 is a configuration diagram showing an image data recording system.

FIG. 2 is a conceptual diagram showing an example in which an image data recording system is applied to a drive recorder.

FIG. 3 is a diagram showing an example of the configuration of a dual-camera image controller.

FIG. 4 is a diagram illustrative of an interlace/progressive conversion mode according to one embodiment of the invention.

FIGS. 5A to 5C are diagrams illustrative of an interlace/progressive conversion mode according to one embodiment of the invention.

FIGS. 6A to 6D are diagrams illustrative of an output mode of a multi-video-input interlace/progressive device.

FIGS. 7A and 7B are diagrams illustrative of an example in which images are automatically scanned according to a selection ratio.

FIG. 8 is a diagram showing the configuration of a multi-video-input interlace/progressive -device.

FIG. 9 is a diagram showing an example of the configuration of a memory controller of a multi-video-input interlace/progressive device.

FIG. 10 is a flowchart showing the flow of a process performed by a read control section.

FIG. 11 is a diagram showing an example of the configuration of a first write control section.

FIG. 12 is a diagram showing an example of the configuration of an MP conversion section.

FIG. 13 is a diagram showing an example of the configuration of a progressive image generation section.

FIG. 14 is a diagram illustrative of an example of the configuration of an edge detection section.

FIGS. 15A to 15C are diagrams illustrative of an example of the configuration of an edge detection section.

FIG. 16 is a diagram illustrative of a configuration that increases the number of input channels.

FIG. 17 is a diagram illustrative of a configuration that increases the number of input channels.

### DETAILED DESCRIPTION OF THE EMBODIMENT

The invention may provide an image processing device, a data recording device, and an image processing control method that can process image data by a simple configuration and be usable with a plurality of imaging devices.

(1) According to one embodiment of the invention, there is provided an image processing device having an interlace/progressive conversion section that receives interlaced image data and converts the interlaced image data into progressive image data,

the interlace/progressive conversion section sequentially receiving image data corresponding to odd-numbered lines or sequentially receiving image data corresponding to even-numbered lines,

the interlace/progressive conversion section performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;

after the even-numbered-line interpolation process, the interlace/progressive conversion section generating a progressive image by using image data corresponding to odd-numbered lines and image data corresponding to even-numbered lines generated by the even-numbered-line interpolation process; and

after the odd-numbered-line interpolation process, the interlace/progressive conversion section generating a progressive image by using image data corresponding to even-numbered lines and image data corresponding to odd-numbered lines generated by the odd-numbered-line interpolation process.

(2) According to one embodiment of the invention, there is provided an image processing device having an interlace/progressive conversion section that receives interlaced image data and converts the interlaced image data into progressive image data, the image processing device comprising:

a conversion mode setting register in which mode information relating to a conversion format is set,

the interlace/progressive conversion section including a normal mode conversion section and an interpolation mode conversion section;

when a value indicating a first mode (a normal mode) is stored in the conversion mode setting register, the normal mode conversion section storing interlaced image data corresponding to odd-numbered lines and interlaced image data corresponding to even-numbered lines received before or after the interlaced image data corresponding to the odd-numbered lines in an image data buffer, and generating a progressive image by using the image data corresponding to the odd-numbered lines or the image data corresponding to the even-numbered lines that is stored in the image data buffer and corresponds to a line number of an image to be output;

when a value indicating a second mode (an interpolation mode) is stored in the conversion mode setting register, the interpolation mode conversion section sequentially receiving image data corresponding to odd-numbered lines or sequentially receiving image data corresponding to even-numbered lines,

the interpolation mode conversion section performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;

after the even-numbered-line interpolation process, the interlace/progressive conversion section generating a progressive image by using image data corresponding to the odd-numbered lines and image data corresponding to the even-numbered lines generated by the even-numbered-line interpolation process; and

after the odd-numbered-line interpolation process, the interlace/progressive conversion section generating a progressive image by using image data corresponding to the even-numbered lines and image data corresponding to the odd-numbered lines generated by the odd-numbered-line interpolation process.

(3) In this image processing device,

the interpolation mode conversion section may include:

an interpolation determination section that stores interlaced image data corresponding to odd-numbered lines and interlaced image data corresponding to even-numbered lines received before or after the interlaced image data corresponding to the odd-numbered lines in the image data buffer, and determines whether or not to interpolate target pixels in an interpolation target line by using pixel values of image data corresponding to the target line and having a predetermined positional relationship with the target pixels and pixel values of image data corresponding to lines preceding and subsequent to the interpolation target line; and

an interpolated value calculation section that calculates interpolated values of the target pixels by using the pixel values of the image data corresponding to the lines preceding and subsequent to the interpolation target line and having a predetermined positional relationship with the target pixels in the interpolation target line; and

the interpolation mode conversion section may generate a progressive image by using the interpolated values or the pixel values of the image data corresponding to the target pixels as the target pixels based on a determination result for whether or not to interpolate the target pixels.

(4) In this image processing device,

the interpolation mode conversion section may include:

an image data buffer read control section that sequentially reads image data corresponding to an nth line (n is an integer) and image data corresponding to an (n+1)th line from the image data buffer, and outputs the read image data to a first output line, a second output line and a third output line; and

an output line data generation section that generates progressive image data based on the input image data from the first output line, the second output line and the third output line into progressive image data, and outputs the progressive image data;

when the image data buffer read control section has read the image data corresponding to the nth line from the image data buffer, the image data buffer read control section may output the read image data to the second output line and write the read image data into a line buffer;

when the image data buffer read control section has read the image data corresponding to the (n+1)th line from the image data buffer, the image data buffer read control section may output the read image data to the third output line, read image data corresponding to an (n+2)th line from the image data buffer, output the read image data corresponding to the (n+2)th line to the second output line, and output image data corresponding to one line stored in the line buffer to the first output line; and

the output line data generation section may output the image data from the second output line as the image data corresponding to the nth line, output the image data from the third output line as the image data corresponding to the (n+1)th line in a normal mode, perform an interpolation process based on the image data from the first output line and the second output line, and output interpolated data as the image data corresponding to the (n+1)th line in an interpolation mode.

(5) In this image processing device,

the image data buffer may include a memory having a capacity smaller than a data volume corresponding to one display image; and

when image data corresponding to a predetermined even-numbered line or odd-numbered line is written into the image data buffer, the image data buffer read control section may start reading previously-written image data corresponding to an even-numbered line or an odd-numbered line of an image in the same frame as the image data corresponding to the predetermined even-numbered line or odd-numbered line.

(6) According to one embodiment of the invention, there is provided an image processing device that receives interlaced image data and converts the interlaced image data into progressive image data, the image processing device comprising:

a conversion mode setting register in which mode information relating to a conversion format is set;

a normal mode conversion section, when a value indicating a first mode (a normal mode) is stored in the conversion mode setting register, the normal mode conversion section storing interlaced image data corresponding to odd-numbered lines and interlaced image data corresponding to even-numbered lines received before or after the image data corresponding to the odd-numbered lines in an image data buffer, and generating a progressive image by using the image data corresponding to the odd-numbered lines or the image data corresponding to the even-numbered lines that is stored in the image data buffer and corresponds to a line number of an image to be output; and

a single-field mode conversion section, when a value indicating a second mode (a single-field mode) is stored in the conversion mode setting register, the single-field mode conversion section generating a progressive image by doubling the image data corresponding to the even-numbered lines or the image data corresponding to the odd-numbered lines.

(7) According to one embodiment of the invention, there is provided a method of controlling an image processing device having an interlace/progressive conversion section that receives interlaced image data and converts the interlaced image data into progressive image data, the method comprising:

sequentially receiving image data corresponding to odd-numbered lines or sequentially receiving image data corresponding to even-numbered lines;

performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;

after the even-numbered-line interpolation process, generating a progressive image by using image data corresponding to odd-numbered lines and image data corresponding to even-numbered lines generated by the even-numbered-line interpolation process; and

after the odd-numbered-line interpolation process, generating a progressive image by using image data corresponding to even-numbered lines and image data corresponding to odd-numbered lines generated by the odd-numbered-line interpolation process.

(8) According to one embodiment of the invention, there is provided an image processing device having image data input terminals respectively provided for a plurality of input channels and an image data output terminal provided for at least one output channel, the image processing device comprising:

an input channel change control section that changes an output target input channel at a predetermined timing; and

an image data selection output section that receives image data corresponding to a first input channel up to image data corresponding to an nth input channel (n is an integer) from the image data input terminals in a predetermined cycle, and selects and outputs the image data from one of the image data input terminals corresponding to the output target input channel.

The image processing device may receive interlaced image data from the image data input terminals respectively provided for a plurality of channels, generate a progressive image based on the image data corresponding to the output target input channel, and output the progressive image from the image data output terminal provided for the output channel.

(9) In this image processing device,

the input channel change control section may alternately assign the input channels to be the output target input channel, and change the output target input channel according to the assignment.

(10) This image processing device may further comprise:

a selection condition setting register in which a condition relating to an image data selection ratio of the input channels is set,

the input channel change control section changing the output target input channel when a count value of a successive selection count of image data corresponding to each of the input channels has reached a successive selection count determined based on a value set in the selection condition setting register.

The input channel change control section may start to count the successive selection count of the output target input channel each time the input channel change control section changes the output target input channel, and change the output target input channel when the count value has reached the successive selection count of the input channel determined based on the value set in the selection condition setting register.

(11) This image processing device may further comprise:

an output mode setting register in which mode information relating to an output format is set,

the input channel change control section not changing the output target input channel when a value indicating a first mode (a fixed mode) is stored in the output mode setting register.

(12) According to one embodiment of the invention, there is provided an image processing device having image data input terminals respectively provided for a plurality of input channels and an image data output terminal provided for at least one output channel, the image processing device comprising:

an output mode setting register in which mode information relating to an output format is set;

an auto scan output section, when a value indicating a zeroth mode (an auto scan mode) is stored in the output mode setting register, the auto scan output section performing an auto scan output process that sequentially changes an output target input channel and selects and outputs image data corresponding to the output target input channel from image data corresponding to the input channels; and

a fixed channel output section, when a value indicating a first mode (a fixed mode) is stored in the output mode setting register, the fixed channel output section performing a fixed channel output process that outputs image data corresponding to a fixed input channel without changing the output target input channel.

(13) This image processing device may further comprise:

a reduced image generation section that generates a first reduced image to an nth reduced image in parallel (n is an integer) based on image data input through one of the image data input terminals corresponding to a first input channel up to one of the image data input terminals corresponding to an nth input channel, and generates a reduced image based on the image data input through the input channels,

when a value indicating a second mode (a reduction mode) is stored in the output mode setting register, the image processing device sequentially outputting the first reduced image to the nth reduced image generated corresponding to image data input through the image data input terminals of the input channels.

The image processing device may receive interlaced image data through a plurality of channels, generate a reduced progressive image, and output the reduced progressive image.

(14) This image processing device may further comprise;

a reduced image generation section that generates a first reduced image to an nth reduced image in parallel (n is an integer) based on image data input through one of the image data input terminals corresponding to a first input channel up to one of the image data input terminals corresponding to an nth input channel, and generates a reduced image based on the image data input through the input channels; and

a merged image generation section that generates a merged image by merging the first reduced image to the nth reduced image,

when a value indicating a third mode (a merging mode) is stored in the output mode setting register, the image processing device outputting the merged image generated by the merged image generation section.

The image processing device may receive interlaced image data through a plurality of channels, generate a merged progressive image, and output the merged progressive image.

(15) According to one embodiment of the invention, there is provided a data recording device comprising:

any of the above-described image processing devices, image data from a plurality of imaging sections being input to the image processing device through image data input terminals respectively provided for a plurality of input channels;

a write section that writes an output from the image processing device into a first storage section;

an image data record event detection section that detects whether or not a predetermined image data record event has occurred; and

a write section that reads image data stored in the first storage section and writes the read image data into a nonvolatile second storage section when occurrence of the predetermined image data record event has been detected.

(16) According to one embodiment of the invention, there is provided a method of controlling an image processing device having image data input terminals respectively provided for a plurality of input channels and an image data output terminal provided for at least one output channel, the method comprising:

changing an output target input channel at a predetermined timing; and

receiving image data corresponding to a first input channel up to image data corresponding to an nth input channel (n is an integer) from the image data input terminals in a predetermined cycle, selecting and outputting the image data from one of the image data input terminals corresponding to the output target input channel.

(17) According to one embodiment of the invention, there is provided a method of controlling an image processing device having image data input terminals respectively provided for a plurality of input channels and an image data output terminal provided for at least one output channel, the method comprising:

setting mode information relating to an output format in an output mode setting register;

when a value indicating a zeroth mode (an auto scan mode) is stored in the output mode setting register, performing an auto scan output process that sequentially changes an output target input channel and selects and outputs image data corresponding to the output target input channel from image data corresponding to the input channels; and

when a value indicating a first mode (a fixed mode) is stored in the output mode setting register, performing a fixed channel output process that outputs image data corresponding to a fixed input channel without changing the output target input channel.

Some embodiments of the invention will be described below, with reference to the drawings. Note that the invention is not limited to the following embodiments. The invention includes configuration in which the elements in the following description are arbitrarily combined.

1. Image Data Recording System

An image data recording system to which the invention is applied is described below.

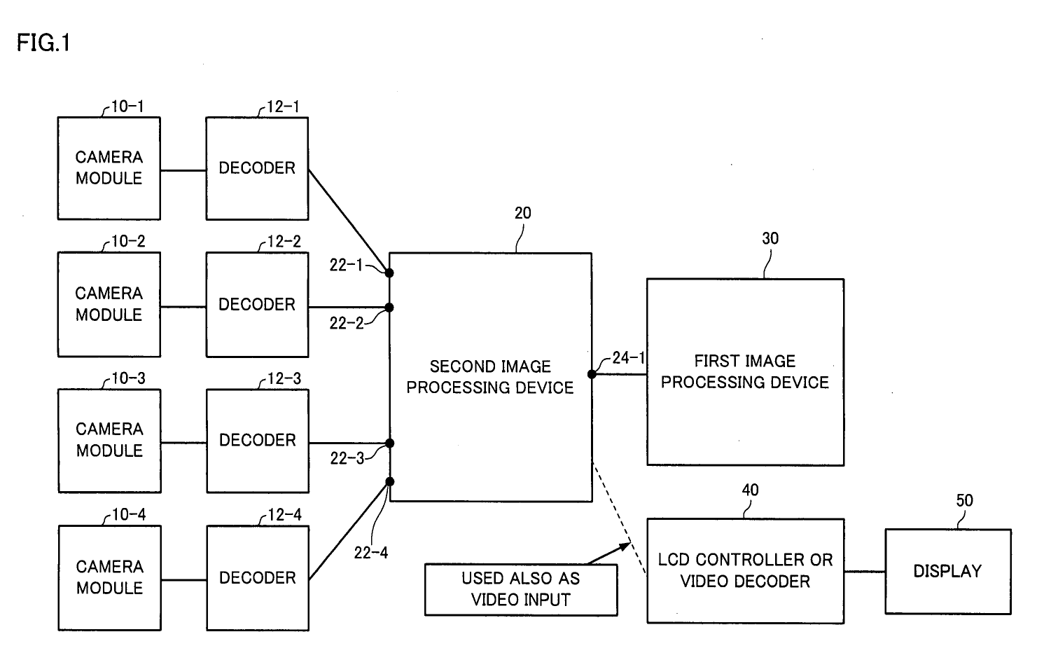

FIG. 1 is a configuration diagram showing an image data recording system 1 (drive recorder or security camera) according to one embodiment of the invention.

Reference numerals 10-1 to 10-4 indicate camera modules (e.g., NTSC/PAL cameras), and reference numerals 12-1 to 12-4 indicate decoders (e.g., NTSC/PAL video decoders).

Reference numeral 20 indicates a second image processing device (multi-video-input interlace/progressive conversion device or IC that converts an interlaced signal into a progressive signal). Digital signals from the NTSC/PAL video decoders 12-1 to 12-4 can be converted into a JPEG image by combining the second image processing device (interlace/progressive conversion device or IC) 20 with a first image processing device (multi-camera image controller) 30 and the like. The interlace/progressive conversion device 20 may include a large-capacity SRAM. Since the interlace/progressive conversion device 20 has a plurality of video input channels, the interlace/progressive conversion device 20 may perform various types of picture output (e.g., fixed picture output, auto scan picture output, and multi-input merging picture output). The second image processing device 20 may have a moving body detection function, and the power consumption of the system may be reduced by causing the second image processing device 20 to issue an interrupt to a host CPU when the second image processing device 20 has detected a moving body.

For example, four camera sets (i.e., camera module and NTSC/PAL decoder) can be connected at a maximum by combining the second image processing device 20 and a single camera-type image controller.

Reference numeral 30 indicates the first image processing device (dual-camera image controller) optimum for a drive recorder, an on-board camera, and the like. The first image processing device 30 has a camera interface function, a JPEG encoder function, a CF (CompactFlash) memory interface, an SD (Secure Digital) memory interface, a USB (device) interface, and an 8 channel ADC. A drive recorder or an on-board camera may be formed by connecting the camera modules 10-1 to 10-4, an SDRAM, an external storage (CF memory card or SD memory card), and a flash ROM which stores firmware to the first image processing device 30. The first image processing device 30 may be configured to perform a camera setting and control an external instrument through a GPIO (General Purpose Input Output) and an 12C bus.

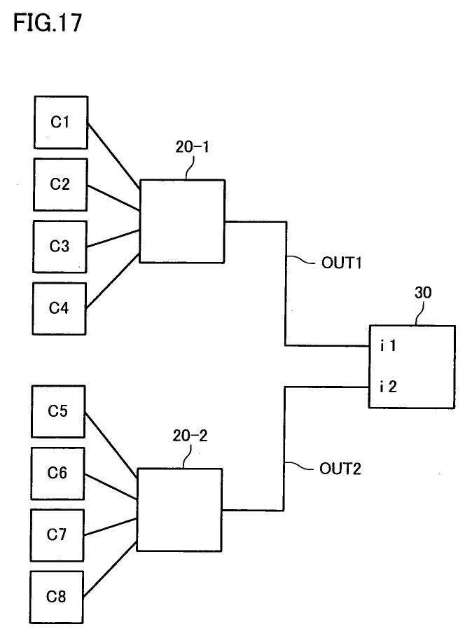

As shown in FIG. 17, eight camera sets C1 to C8 can be connected to the first image processing device 30 by connecting outputs OUT1 and OUT2 of second image processing devices 20-1 and 20-2 to inputs i1 and i2 of the first image processing device 30, for example.

When using the data recording system as a security camera, an output from the second image processing device 20 may be supplied to an LCD controller or a video decoder 40 and a display 50, and displayed on the display 50.

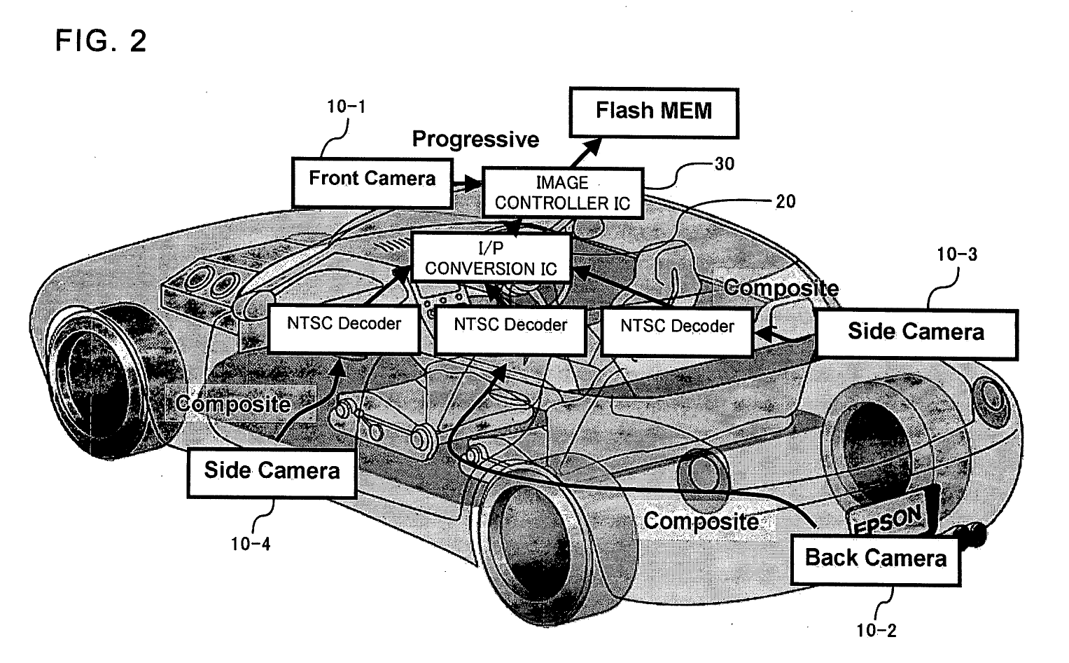

FIG. 2 is a conceptual diagram showing an example in which the image data recording system 1 according to this embodiment is applied to a drive recorder.

As shown in FIG. 2, the image data recording system 1 according to this embodiment includes a front camera 10-1 that photographs the front side of the vehicle body (outputs progressive digital image data), a back camera 10-2 that photographs the rear side of the vehicle body (outputs interlaced analog image data), a side camera 10-3 that photographs the left side of the vehicle body with respect to the travel direction (outputs interlaced analog image data), and a side camera 10-4 that photographs the right side of the vehicle body with respect to the travel direction (outputs interlaced analog image data).

Since the first image processing device 30 is a dual-camera image controller IC, the front camera 10-1 that photographs the front side of the vehicle body (outputs progressive digital image data) is connected to a first camera interface of the first image processing device 30, and the interlace/progressive conversion device 20 is connected to a second camera interface of the first image processing device 30.

Since the second image processing device 20 has four video input channels, the back camera 10-2 that photographs the rear side of the vehicle body (outputs interlaced analog image data), the side camera 10-3 that photographs the left side of the vehicle body with respect to the travel direction (outputs interlaced analog image data), and the side camera 10-4 that photographs the right side of the vehicle body with respect to the travel direction (outputs interlaced analog image data) are connected to the video input channels through NTSC decoders.

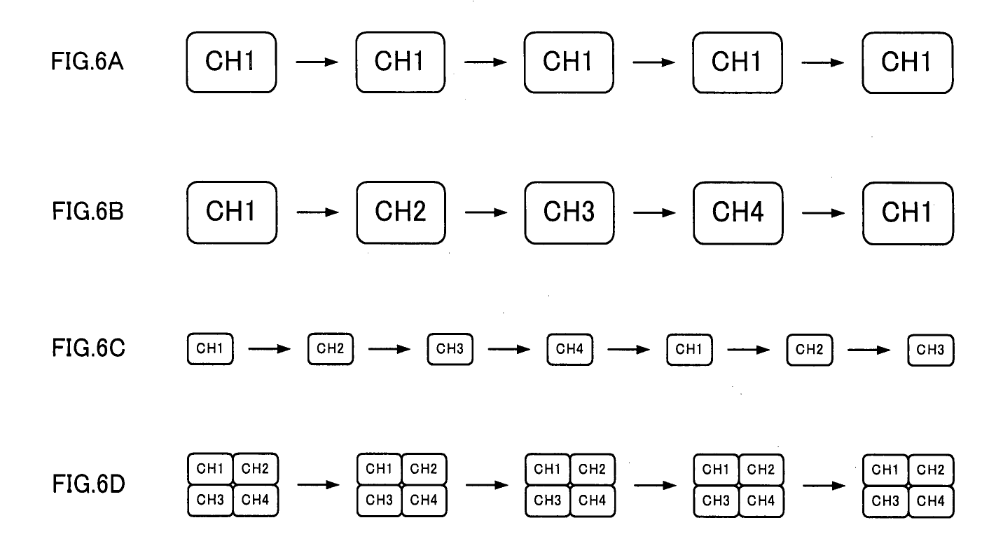

An image photographed by the back camera 10-2, an image photographed by the side camera 10-3, and an image photographed by the side camera 104 can be sequentially output by causing the second image processing device 20 to perform auto scan picture output (see FIG. 6B).

An image photographed by the back camera 10-2, an image photographed by the side camera 10-3, and an image photographed by the side camera 10-4 can be merged and output by causing the second image processing device 20 to perform multi-input merging picture output (see FIG. 6D).

2. First Image Processing Device (Dual-Camera Image Controller or IC)

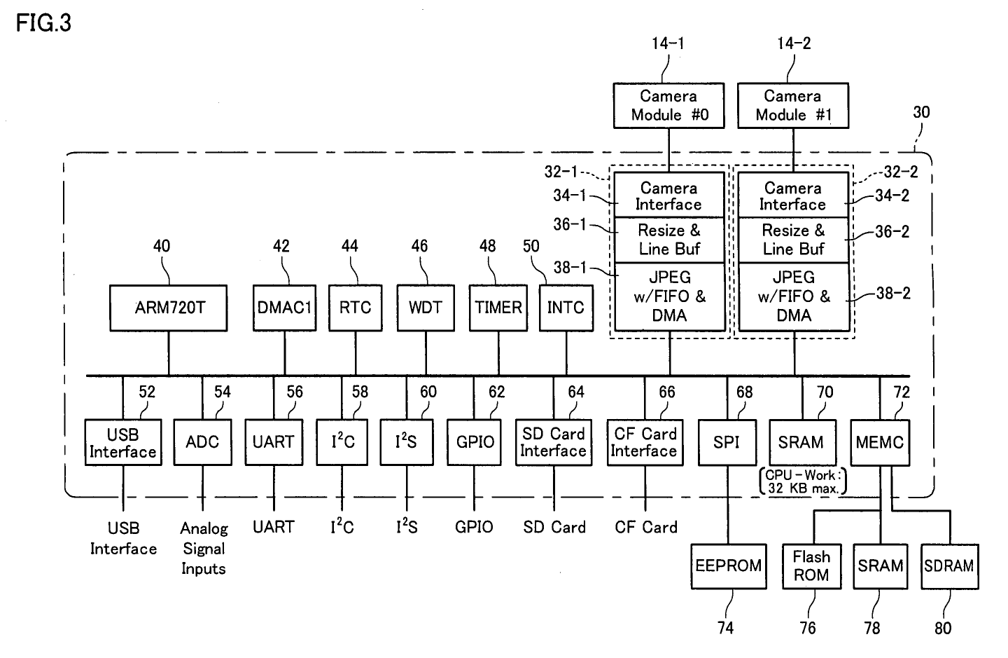

FIG. 3 is a diagram showing an example of the configuration of the first image processing device (dual-camera image controller) according to this embodiment.

The first image processing device (dual-camera image controller) 30 includes an image processing section 32-1 that processes image data input from a first camera module 14-1. The image processing section 32-1 includes a camera I/F 34-1, a resizing section 36-1, a compression section 38-1, and the like. The first image processing device 30 includes an image processing section 32-2 that processes image data input from a second camera module 14-2. The image processing section 32-2 includes a camera I/F 34-2, a resizing section 36-2, a compression section 38-2, and the like. The compression section 38-1 and the compression section 38-2 implement hardware JPEG encoding at 30 fps VGA.

The first image processing device 30 includes two hardware JPEG encoders (compression sections 38-1 and 38-2) corresponding to the camera modules.

The first image processing device 30 may include an I2S 60 that supports sound data.

The first image processing device 30 may include a CF card I/F 66 for a CF memory card compliant with the CompactFlash interface standard.

The first image processing device 30 may include a wireless LAN interface (802.11b/g) compliant with the CompactFlash interface standard.

The first image processing device 30 may include an SD memory card I/F 64 for SD memory card compliant with the SD memory interface standard.

The first image processing device 30 includes a USB interface 52 for connection with a PC.

The first image processing device 30 may include an ADC 54 which can be connected to various analog sensors such as a gyrosensor.

The first image processing device 30 may include an event count timer 48 that measures a velocity pulse, for example.

The first image processing device 30 may include a two-port (16 bit-bus: FROM/SRAM, 32 bit-bus: SDRAM) memory bus.

3. Interlace/Progressive Conversion Mode

In this embodiment, when converting interlaced image data into progressive image data, the conversion mode can be selected from a normal mode in which successive fields are synthesized to create one frame, a single-field mode in which each line is doubled using only a single field to create one frame, and an interpolation mode in which upper and lower lines are linearly interpolated using only a single field to create one frame.

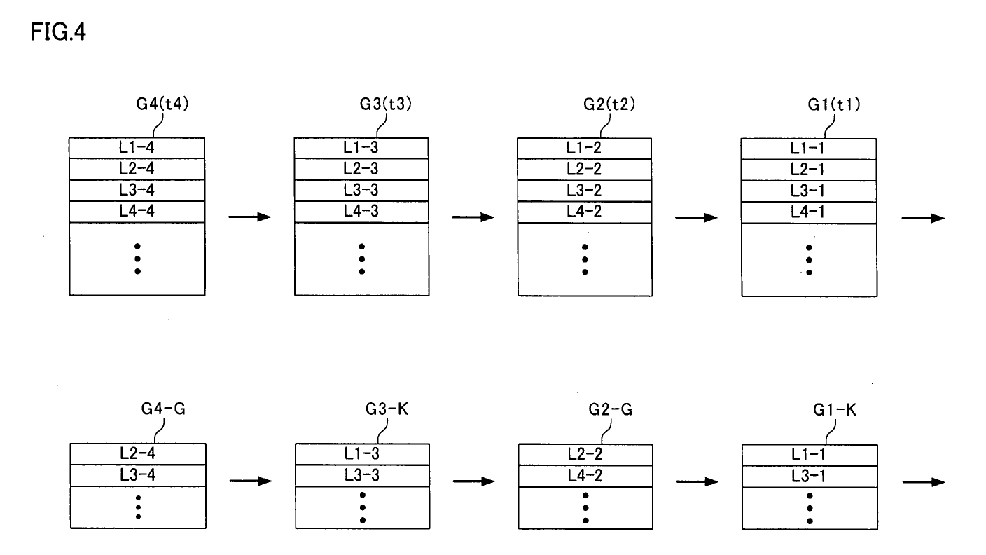

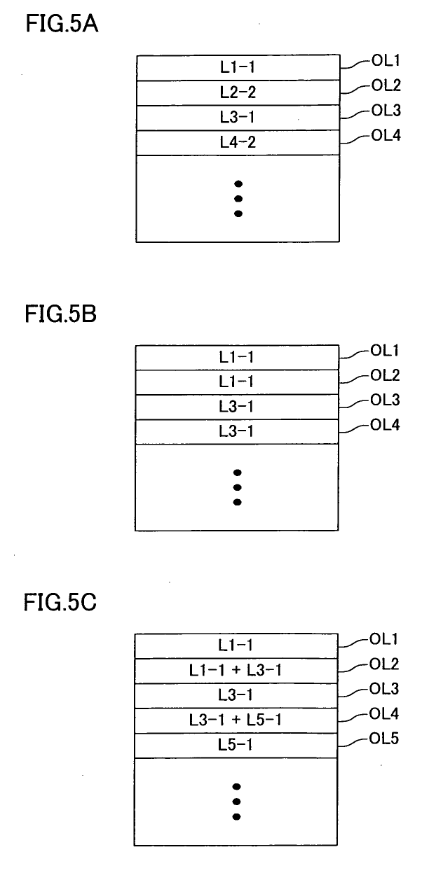

FIGS. 4, 5A, 5B, and 5C are diagrams illustrative of the interlace/progressive conversion mode according to this embodiment.

Interlaced image data is input to each input channel of the second image processing device 20 according to this embodiment. As shown in FIG. 4, original images G1, G2, G3, and G4 are acquired at times t1, t2, t3, t4, . . . every 1/60th of a second, for example, and an image G1-K of the odd-numbered lines of the original image G1, an image G2-G of the even-numbered lines of the original image G2, an image G3-K of the odd-numbered lines of the original image G3, an image G4-G of the even-numbered lines of the original image G4, . . . are input in time series to a data terminal of the input channel of the interlace/progressive conversion device 20 according to this embodiment every 1/60th of a second.

In the normal mode, as shown in FIG. 5A, a progressive image is generated in which odd-numbered lines OL1, OL3, . . . of the output image correspond to the data L1-1, L3-1, . . . relating to the corresponding lines of the image G1-K of the odd-numbered lines of the original image G1, and even-numbered lines OL2, OL4, . . . of the output image correspond to the data L2-2, L4-2, . . . relating to the corresponding lines of the image G2-G of the even-numbered lines of the original image G2.

In the single-field mode, as shown in FIG. 5B, a progressive image is generated in which an odd-numbered line OL(n) and an even-numbered line OL(n+1) of the output image correspond to the data L1-n relating to the corresponding line of the image G1-K of the odd-numbered lines of the original image G1.

In the interpolation mode, as shown in FIG. 5C, a progressive image is generated in which odd-numbered lines OL1, OL3, . . . of the output image correspond to the data L1-1, L3-1, . . . relating to the corresponding lines of the image G1-K of the odd-numbered lines of the original image G1, and data relating to even-numbered lines OL2, OL4, . . . of the output image is generated by interpolating the pixel values of two consecutive odd-numbered target lines (odd-numbered lines preceding and subsequent to the even-numbered line to be generated) of the image G1-K of the odd-numbered lines of the original image G1. For example, the pixel values of the even-numbered line OL2 of the output image are generated by performing linear interpolation calculations based on the pixel values of the lines L1 and L3 (odd-numbered lines preceding and subsequent to the even-numbered line to be generated) of the image G1-K of the odd-numbered lines of the original image G1.

When an object in the photographing area has moved, an object H-1 in the odd-numbered-line image G1-K acquired at the time t1 may differ from an object H-2 in the even-numbered-line image G2-G acquired at the time t2. In this case, a blurred image is generated due to the difference between the odd-numbered-line image and the even-numbered-line image.

In the single-field mode according to this embodiment, since a progressive image is generated without mixing the odd-numbered-line image and the even-numbered-line image, blurring can be prevented.

4. Output Format

FIGS. 6A to 6D are diagrams illustrative of the output mode of the second image processing device 20 according to this embodiment.

In this embodiment, a plurality of modes including a fixed mode, an auto scan mode, a reduction mode, and a merging mode are provided as the output format of images input through a plurality of input channels. An image in an output format corresponding to the selected output mode is output.

In the fixed mode, an image input through one input channel determined in advance is output, as shown in FIG. 6A. In the auto scan mode, images are output while sequentially changing the input channels, as shown in FIG. 6B. In the reduction mode, an image is output in a reduced size (e.g., a VGA image is resized to a QVGA image), as shown in FIG. 6C. For example, when the data size is reduced by a factor of four (¼), four images are output in a period in which one image is output in the fixed mode. In the merging mode, images input through the respective channels are resized to QVGA images, synthesized, and output as one image, as shown in FIG. 6C.

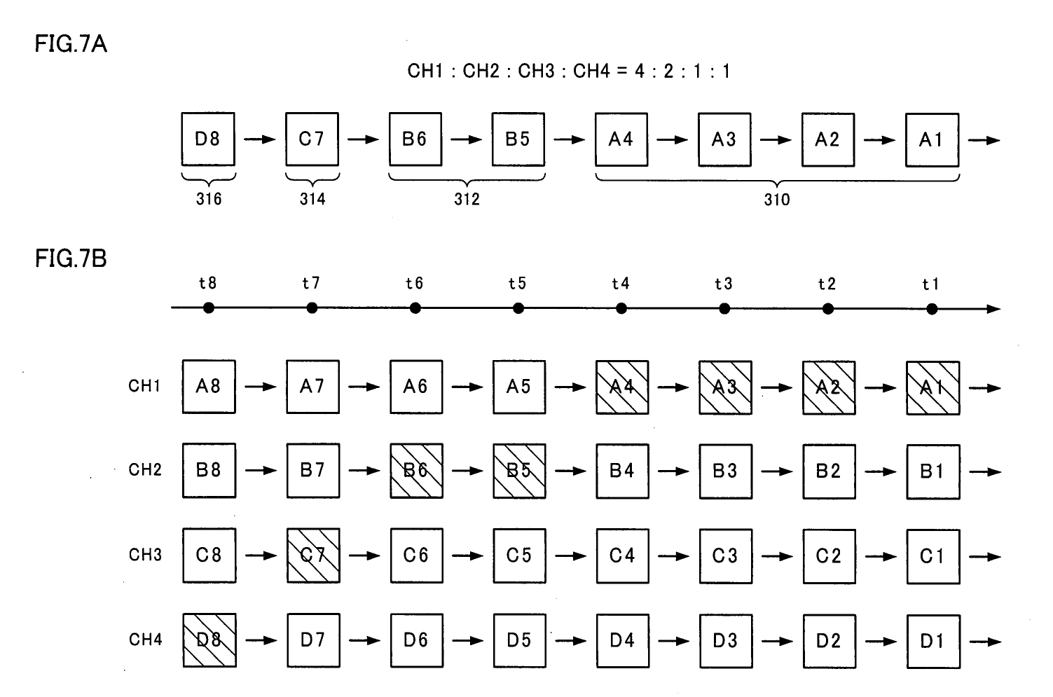

FIGS. 7A and 7B are diagrams illustrative of an example in which images are automatically scanned according to a selection ratio.

The second image processing device 20 according to this embodiment sequentially performs control that determines a successive selection count corresponding to each input channel according to a selection ratio set in a selection condition setting register or the like, and successively selects image data corresponding to each input channel in the successive selection count determined corresponding to each input channel.

As shown in FIG. 7B, image data A1, A2, A3, . . . is input through an input channel CH1 at times t1, t2, t3, . . . at intervals of 1/30th of a second, image data B1, B2, B3, . . . is input through an input channel CH2 at intervals of 1/30th of a second, image data C1, C2, C3, . . . is input through an input channel CH3 at intervals of 1/30th of a second, and image data D1, D2, D3, . . . is input through an input channel CH4 at intervals of 1/30th of a second, for example.

When the selection ratio CH1:CH2:CH3:CH4=4:2:1:1 is set, the image data A1, A2, A3, A4, B5, B6, C7, D8, . . . is output in this order at intervals of 1/30th of a second, as shown in FIG. 7A. Specifically, four images input through the input channel CH1 are successively selected (310), two images input through the input channel CH2 are then successively selected, one image input through the input channel CH3 is then selected, and one image input through the input channel CH4 is then selected. This process is repeated.

5. Configuration of Second Image Processing Device

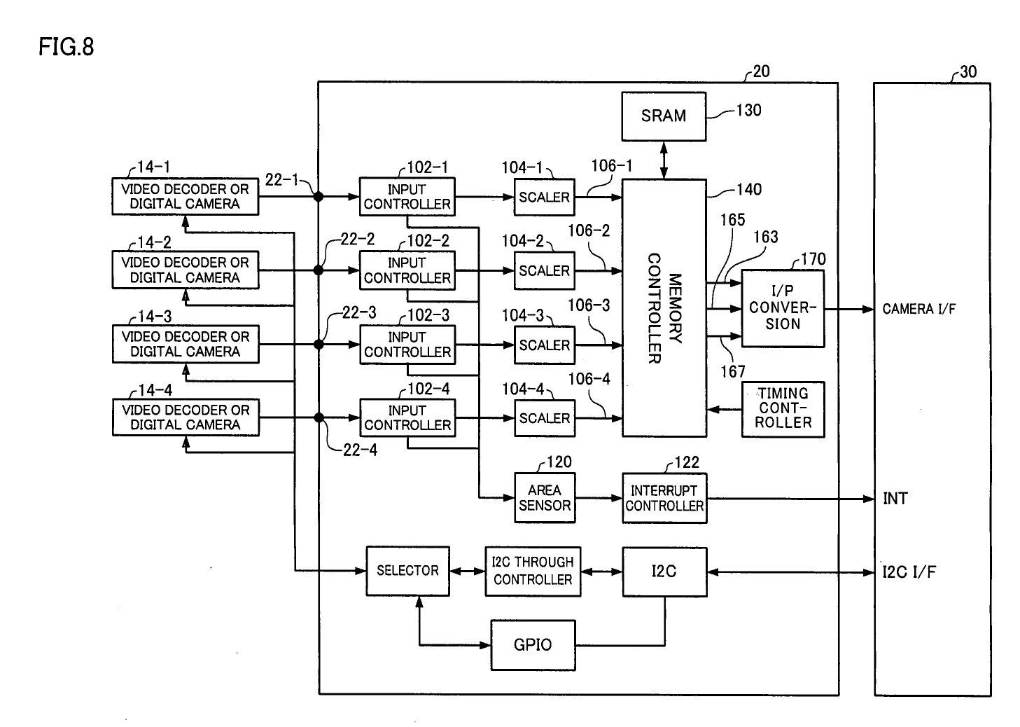

FIG. 8 is a diagram showing the configuration of the second image processing device according to this embodiment.

The second image processing device 20 according to this embodiment is an IC that converts an interlaced signal into a progressive signal. Since the second image processing device 20 according to this embodiment includes an SRAM 130 sufficient to convert an interlaced signal into a progressive signal, the second image processing device 20 can convert an interlaced signal into a progressive signal without using an external RAM.

The second image processing device 20 according to this embodiment has four video input channels 22-1, 22-2, 22-3, and 22-4, and can perform various types of picture output (e.g., fixed picture output, auto scan picture output, and multi-input merging picture output). The second image processing device 20 according to this embodiment has a moving body detection function, and can issue an interrupt to a host CPU when the second image processing device 20 has detected a moving body. Therefore, the power consumption of the system can be reduced.

The second image processing device 20 according to this embodiment includes input controllers 102-1 to 102-4 that control the input timings of image data through the channels 22-1 to 22-4. The second image processing device 20 according to this embodiment includes scalers 104-1 to 104-4 that resize image data output from the input controllers 102-1 to 102-4. In the reduction mode or the merging mode, the scalers 104-1 to 104-4 reduce the number of pixels of each line of the input image by half to reduce the length of the data row by half.

The second image processing device 20 according to this embodiment includes a memory controller 140 that writes outputs from the scalers 104-1 to 104-4 into the SRAM 130, reads image data from the SRAM 130 at a given timing, and outputs the image data to a first output line 163, a second output line 165, and a third output line 167.

The second image processing device 20 according to this embodiment includes an I/P conversion section (an output line data generation section) 170 that receives the image data through the first output line 163, the second output line 165, and the third output line 167, and outputs progressive image data.

The second image processing device 20 according to this embodiment includes an area sensor 120 that performs moving body detection and brightness detection, and an interrupt controller 122 that generates an interrupt signal based on the moving body detection result and the brightness detection result.

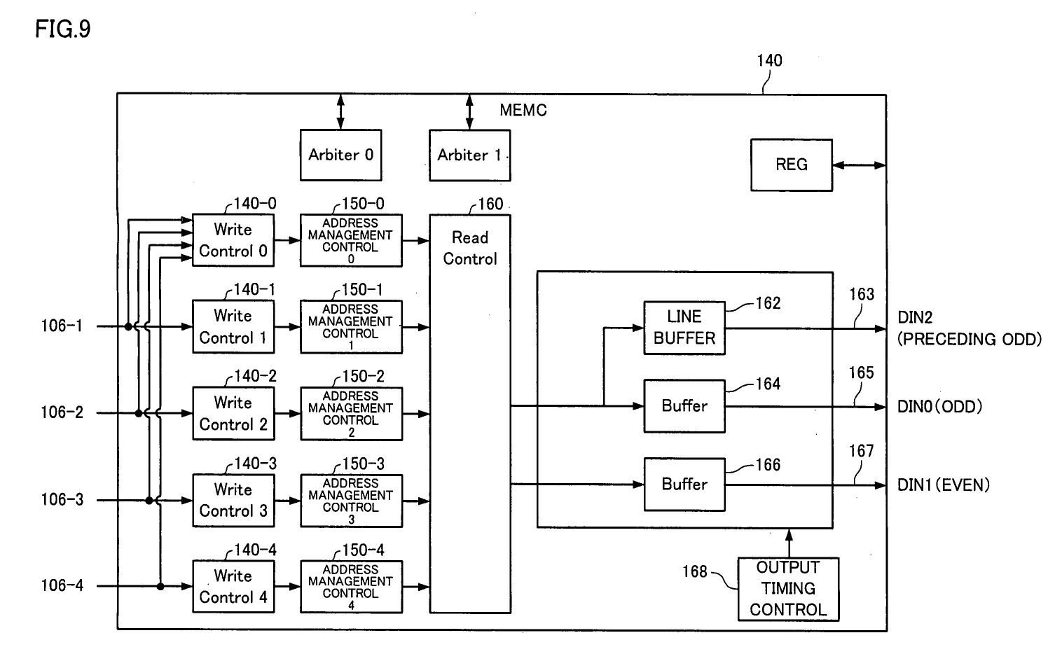

FIG. 9 is a diagram showing an example of the configuration of the memory controller of the second image processing device according to this embodiment.

The memory controller 140 includes a first write control section 140-0 to a fifth write control section 140-4 that control writing of image data into the SRAM 130, a first address management control section 150-0 to a fifth address management control section 150-4 that manage the image data write/read address of the SRAM 130 corresponding to write control performed by the first write control section 140-0 to the fifth write control section 140-4 and read control performed by a read control section 160, the read control section 160 that controls reading of image data from the SRAM 160, a line buffer 162 that is provided in the preceding stage of the first output line 163 to which the read image data is output and can hold image data corresponding to at least one line of the display image, a buffer 164 provided on the second output line 165, a buffer 166 provided on the third output line 166, and an output timing control section 168 that controls the output timing corresponding to each output line.

The memory controller 140 receives image data 106-1 to 1064 output from the scalers 104-1 to 104-4 corresponding to the input channels 22-1 to 22-4. In the fixed mode or the auto scan mode, the image data 106-1 to 106-4 is image data which is not reduced in size. In the reduction mode or the merging mode, the image data 106-1 to 106-4 is image data reduced in size.

The image data 106-1 to 106-4 input through four input channels is input to the first write control section 140-0. The image data 106-1 input through the first input channel is input to the second write control section 140-1. The image data 106-2 input through the second input channel is input to the third write control section 140-2. The image data 106-3 input through the third input channel is input to the fourth write control section 140-3. The image data 106-4 input through the fourth input channel is input to the fifth write control section 140-4.

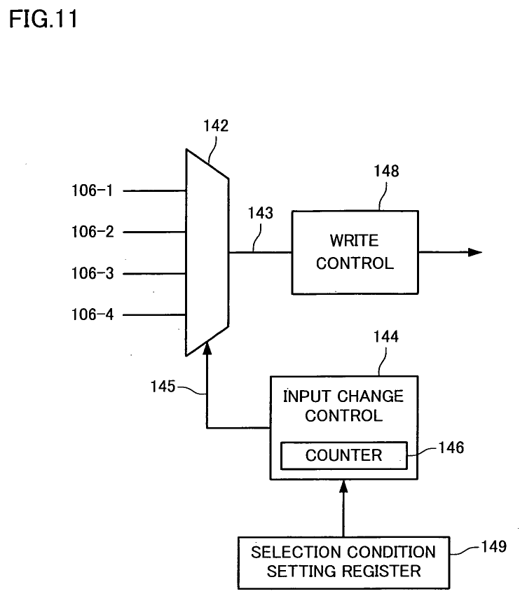

The first write control section 140-0 operates in the fixed mode or the auto scan mode. In the fixed mode, image data input through a given input channel is stored in the SRAM 130. In the auto scan mode, output target image data selected from the image data input through each input channel is stored in the SRAM 130. The configuration of the first write control section 140-0 is described later with reference to FIG. 11.

The second write control section 140-1 to the fifth write control section 140-4 operate in the reduction mode or the merging mode. In the reduction mode or the merging mode, the second write control section 140-1 writes reduced image data input through the first input channel into the SRAM 130. The third write control section 140-2 writes reduced image data input through the second input channel into the SRAM 130. The fourth write control section 140-3 writes reduced image data input through the third input channel into the SRAM 130. The fifth write control section 140-4 writes reduced image data input through the fourth input channel into the SRAM 130.

The read control section 160 reads the image data stored in the SRAM 130. The read control section 160 outputs the preceding line output to the first output line, outputs the odd-numbered-line output to the second output line, and outputs the even-numbered-line output to the third output line.

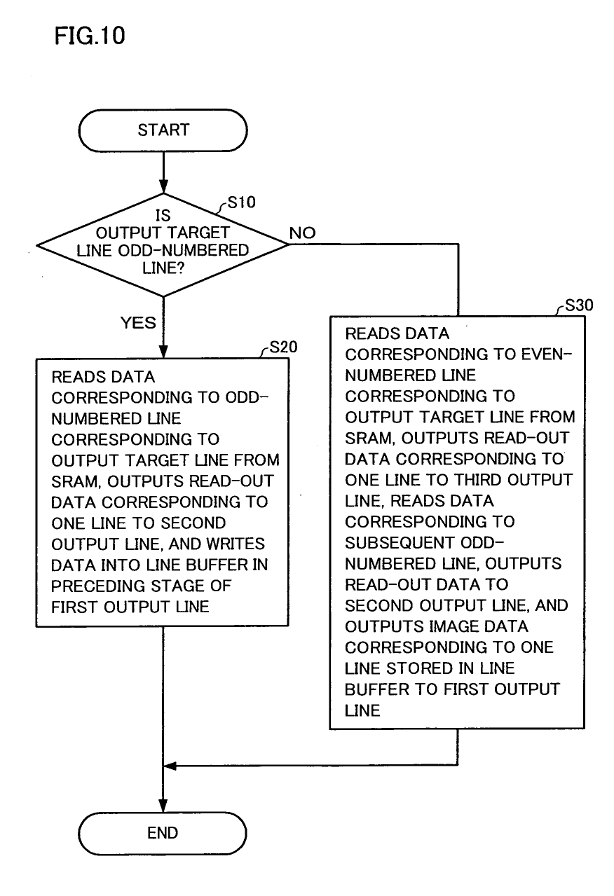

FIG. 10 is a flowchart showing the flow of a process performed by the read control section 160.

The read control section 160 determines whether or not the output target line is an odd-numbered line or an even-numbered line (step S10). When the output target line is an odd-numbered line, the read control section 160 reads data relating to the odd-numbered line corresponding to the output target line from the SRAM 130, outputs the data corresponding to one line read from the SRAM 130 to the second output line 165, and writes the data into the line buffer 162 in the preceding stage of the first output line 163 (step S20).

When the output target line is an even-numbered line, the read control section 160 reads data relating to the even-numbered line corresponding to the output target line from the SRAM 130, outputs the data corresponding to one line read from the SRAM 130 to the third output line 167, reads data relating to the subsequent odd-numbered line, outputs the read data to the second output line 165, and outputs image data corresponding to one line stored in the line buffer 162 to the first output line 163 (step S30).

FIG. 11 is a diagram showing an example of the configuration of the first write control section 140-0.

The first write control section 140-0 includes a selection section 142, a selection condition setting register 149, an input change control section 144, and a write control section 148. The selection section 142 receives the image data 106-1 to 106-4 corresponding to the first to fourth input channels, selects one piece of input data based on a selection control signal 145, and outputs selected image data 143. A value that indicates a condition relating to the selection ratio of each input channel is set in the selection condition setting register 149. The value stored in the selection condition setting register 149 may be set or changed based on an external input. The input change control section 144 includes a counter 146. The input change control section 144 determines the number of times that an image input through each input channel is successively selected based on the value set in the selection condition setting register, and generates the selection control signal 145 for changing the input channel based on the determined number. The write control section 148 writes the selected image data 143 selected by the selection section into the SRAM 130.

In the auto scan mode, the image data can be thus selected based on the selection ratio set in the selection condition setting register and stored in the SRAM 130. In the fixed mode, the selection ratio of the selected channel may be set at one, and the selection ratio of other channels may be set at zero.

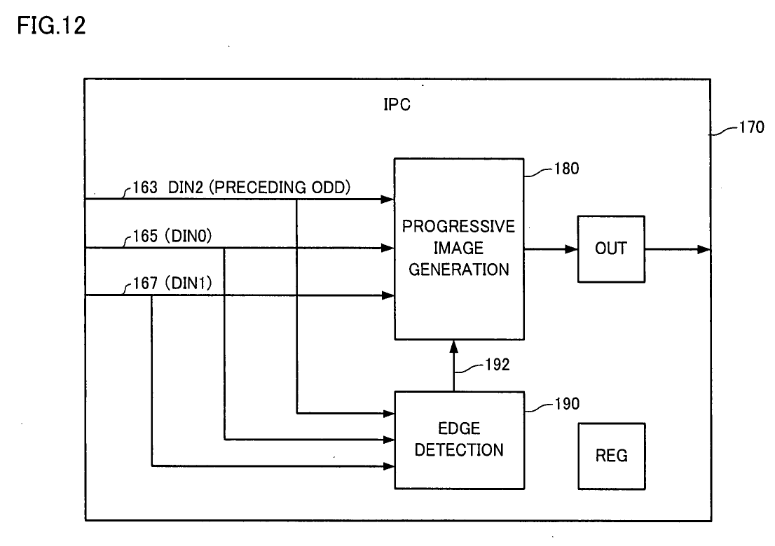

FIG. 12 is a diagram showing an example of the configuration of the I/P conversion section 170.

The I/P conversion section 170 includes a progressive image generation section 180 and an edge detection section 190.

The progressive image generation section 180 receives image data input through the first output line 163, image data input through the second output line 165, and image data input through the third output line 167, generates a progressive image in a format corresponding to the interlace/progressive conversion mode, and outputs the progressive image.

In the interpolation mode, the edge detection section 190 functions as an interpolation determination section that determines whether or not to calculate an interpolated value of each pixel of the image data corresponding to the even-numbered line ((n+1)th line) corresponding to the output target line based on the pixel values of the image data corresponding to the even-numbered line ((n+1)th line) corresponding to the output target line, the pixel values of the image data corresponding to the odd-numbered line (nth line) preceding the even-numbered line corresponding to the output target line and having a predetermined positional relationship with the pixel values of the image data corresponding to the even-numbered line ((n+1)th line), and the pixel values of the image data corresponding to the odd-numbered line ((n+2)th line) subsequent to the even-numbered line corresponding to the output target line and having a predetermined positional relationship with the pixel values of the image data corresponding to the even-numbered line ((n+1)th line), based on the image data corresponding to the odd-numbered line (nth line) preceding the even-numbered line corresponding to the output target line, the image data corresponding to the even-numbered line ((n+1)th line) corresponding to the output target line, and the image data corresponding to the odd-numbered line ((n+2)th line) subsequent to the even-numbered line corresponding to the output target line, and outputs an interpolation control signal 192.

In the interpolation mode, when the progressive image generation section 180 generates the image data corresponding to the even-numbered line ((n+1)th line) corresponding to the output target line, the progressive image generation section 180 determines whether to use the pixel value of the even-numbered line ((n+1)th line) or an interpolated value calculated based on the pixel values (e.g., the pixel values of the corresponding rows) of the preceding and subsequent odd-numbered lines having a predetermined relationship with the pixel values of the even-numbered line ((n+1)th line) based on the interpolation control signal 192, and generates image data corresponding to the even-numbered line.

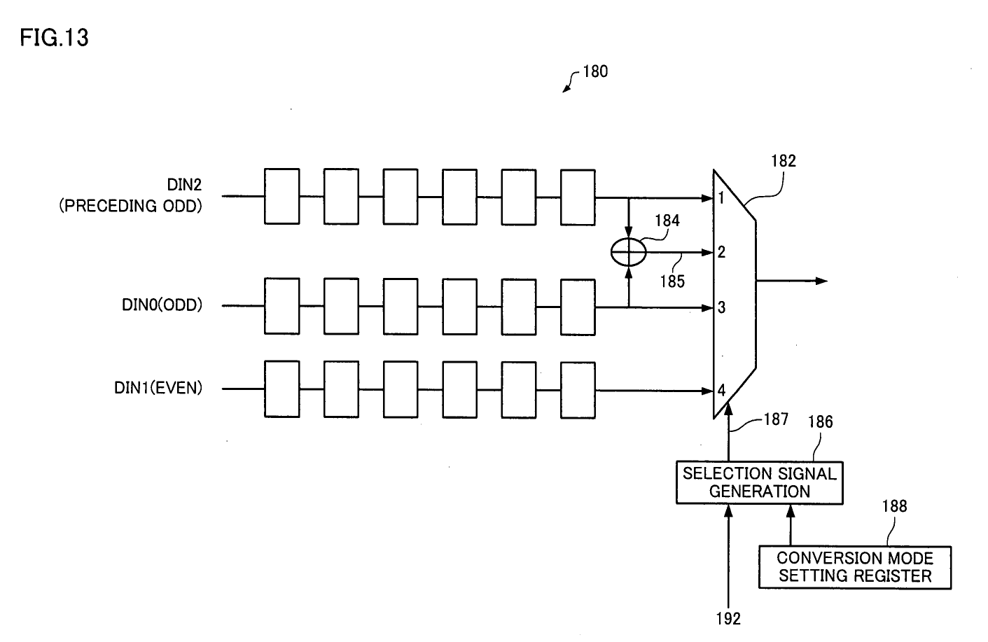

FIG. 13 shows an example of the configuration of the progressive image generation section 180.

The progressive image generation section 180 includes an interpolated value calculation section 184, an output selection section 182, a selection signal generation section 186, and a conversion mode setting register 188. The progressive image generation section 180 receives image data relating to a line DIN2 (preceding odd-numbered line), a line DIN1 (even-numbered line), and a line DIN0 (odd-numbered line). The interpolated value calculation section 184 performs interpolation calculations based on the corresponding pixel values (pixel values in the same row) in the line DIN2 (preceding odd-numbered line) and the line DIN0 (odd-numbered line) to generate an interpolated value 185.

A value that indicates whether the conversion mode is the normal mode, the single-field mode, or the interpolation mode is set in the conversion mode setting register 188.

The output selection section 182 receives the image data corresponding to the line DIN2 (preceding odd-numbered line) at an input 1, receives the interpolated image data (value) 185 at an input 2, receives the image data corresponding to the line DIN0 (odd-numbered line) at an input 3, and receives the image data corresponding to the line DIN1 (even-numbered line) at an input 4, and selectively outputs one piece of image data based on the selection control signal.

The selection signal generation section 186 generates a selection control signal 187 for controlling the input value selected by the output selection section based on the value set in the conversion mode setting register 188 and the interpolation control signal 192 output from the edge detection section 190.

In the normal mode, the output selection section 182 alternately selects and outputs the image data corresponding to the line DIN0 (odd-numbered line) and the image data corresponding to the line DIN1 (even-numbered line). Specifically, the selection signal generation section 186 generates a selection control signal (3-4-3-4, . . . ) for alternately selecting the input 3 and the input 4 corresponding to each line.

In the single-field mode, the output selection section 182 alternately selects and outputs the image data corresponding to the line DIN2 (preceding odd-numbered line) and the image data corresponding to the line DIN0 (odd-numbered line). Specifically, the selection signal generation section 186 generates a selection control signal (3-1-3-1, . . . ) for alternately selecting the input 3 and the input 1 corresponding to each line.

In the interpolation mode, the output selection section 182 selects the image data corresponding to the line DIN0 (odd-numbered line) when the output target is an odd-numbered line, and selects the image data corresponding to the line DIN1 (even-numbered line) or the interpolated value 184 based on the interpolation control signal 192 corresponding to each pixel when the output target is an even-numbered line. Specifically, the selection signal generation section 186 generates a selection control signal (3-4 or 2-3-4 or 2, . . . ) for alternately selecting the input 3 and the input 4 or 2 corresponding to each line.

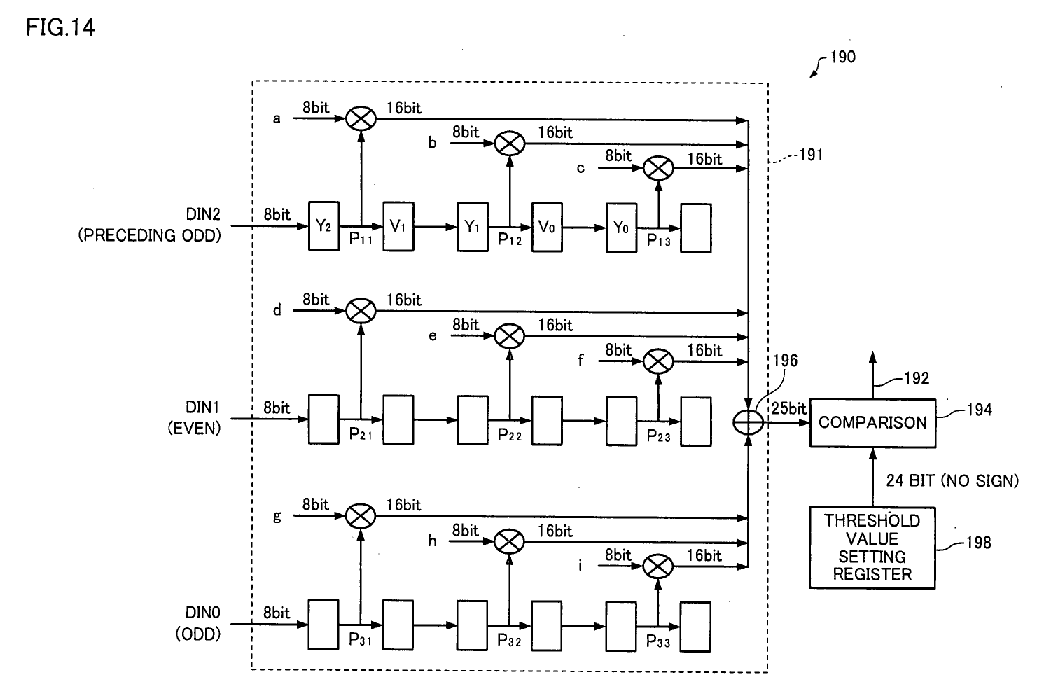

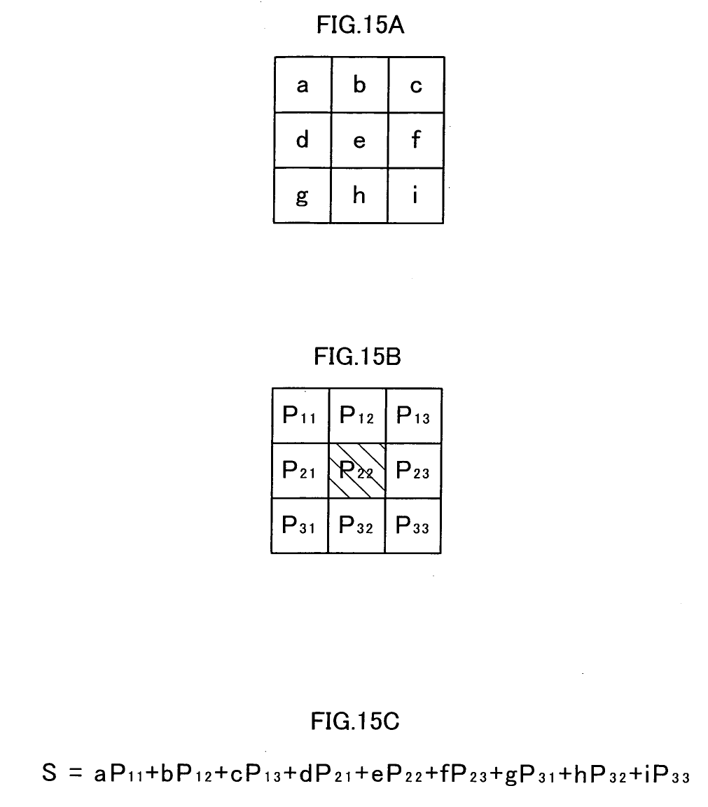

FIG. 14 and FIGS. 15A to 15C are diagrams illustrative of an example of the configuration of the edge detection section.

As shown in FIG. 14, the edge detection section 190 includes a filter calculation section 191, a comparison section 194, and a threshold value setting register 198. The filter calculation section 191 receives the image data corresponding to the line DIN2 (preceding odd-numbered line), the image data corresponding to the line DIN1 (even-numbered line), and the image data corresponding to the line DIN0 (odd-numbered line). In this embodiment, since image data is input in a YUV ratio of 4:2:2, image data is input to the first input line in the order of Y0, U0, Y1, V1, Y2, for example. The filter calculation section 191 calculates the difference in Y component using a filter.

The memory controller writes the image data corresponding to the current odd-numbered line into the line DIN0 (odd-numbered line) when the current line (output target line) is an odd-numbered line. When the current line (output target line) is an even-numbered line, the memory controller writes the image data corresponding to the subsequent odd-numbered line into the line DIN0 (odd-numbered line), writes the image data corresponding to the current odd-numbered line into the line DIN, and writes the image data corresponding to the preceding odd-numbered line into the DIN2 (preceding odd-numbered line). The image data is written in the order of Cb-Y0-Cr-Y1. Cb and Cr are determined using the results for Y0.

The filter sets coefficients shown in FIG. 15A corresponding to nine pixel values (center pixel is a pixel P22) shown in FIG. 15B, and calculates an edge determination value S by multiplying the pixel values by the corresponding coefficients, as shown in FIG. 15C.

The comparison section 164 compares the edge determination value S with a threshold value set in the threshold value setting register 198. When the edge determination value S exceeds the threshold value, the comparison section 164 outputs the interpolation control signal 192 that indicates that interpolation is required. When the edge determination value S does not exceed the threshold value, the comparison section 164 outputs the interpolation control signal 192 that indicates that interpolation is not required.

The above control enables a progressive image to be generated in the normal mode, the interpolation mode, and the single-field mode. In the interpolation mode, an interpolation process is performed only on pixels of which the edge determination value exceeds the threshold value (pixels forming a moving object), and the pixels of the original image can be output for pixels of which the edge determination value is equal to or less than the threshold value (pixels forming a stationary object).

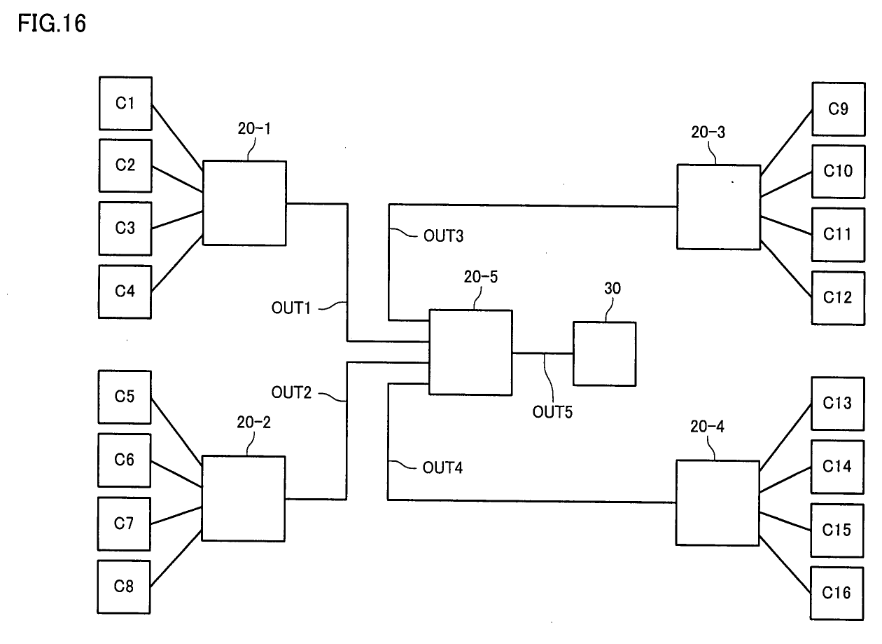

FIG. 16 is a diagram illustrative of a configuration which increases the number of input channels by inputting an output from a second image processing device to another second image processing device.

FIG. 16 shows an example in which sixteen input channels are substantially implemented by connecting sixteen camera modules C1 to C16, five second image processing devices 20-1 to 20-5, and one first image processing device 30.

For example, image data from the camera modules C1 to C4 is supplied to input channels of the second image processing device 20-1, image data from the camera modules C5 to C8 is supplied to input channels of the second image processing device 20-2, image data from the camera modules C9 to C12 is supplied to input channels of the second image processing device 20-3, and image data from the camera modules C13 to C16 is supplied to input channels of the second image processing device 20-4. When the second image processing devices 20-1 to 20-4 are set in the auto scan mode, the reduction mode, or the merging mode, outputs OUT1, OUT2, OUT3, and OUT4 from the image processing devices 20-1 to 20-4 respectively include image data from the camera modules C1 to C4, image data from the camera modules C5 to C8, image data from the camera modules C9 to C12, and image data from the camera modules C13 to C16. When the outputs OUT1, OUT2, OUT3, and OUT4 are supplied to four inputs of the second image processing device 20-5, and the second image processing device 20-5 is set in the auto scan mode, the reduction mode, or the merging mode, an output OUT5 from the second image processing device 20-5 includes images photographed by the sixteen camera modules C1 to C16.

An image processing device having an arbitrary number of input channels can be implemented by a simple configuration by combining a plurality of second image processing devices according to this embodiment.

The invention is not limited to the above-described embodiments, and various modifications can be made. The invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. An image processing device having an interlace/progressive conversion section that receives interlaced image data and converts the interlaced image data into progressive image data,
the interlace/progressive conversion section sequentially receiving image data corresponding to odd-numbered lines or sequentially receiving image data corresponding to even-numbered lines,
the interlace/progressive conversion section performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;
after the even-numbered-line interpolation process, the interlace/progressive conversion section generating a progressive image by using image data corresponding to odd-numbered lines and image data corresponding to even-numbered lines generated by the even-numbered-line interpolation process; and
after the odd-numbered-line interpolation process, the interlace/progressive conversion section generating a progressive image by using image data corresponding to even-numbered lines and image data corresponding to odd-numbered lines generated by the odd-numbered-line interpolation process.

2. An image processing device having an interlace/progressive conversion section that receives interlaced image data and converts the interlaced image data into progressive image data, the image processing device comprising:
a conversion mode setting register in which mode information relating to a conversion format is set,
the interlace/progressive conversion section including a normal mode conversion section and an interpolation mode conversion section;
when a value indicating a first mode is stored in the conversion mode setting register, the normal mode conversion section storing interlaced image data corresponding to odd-numbered lines and interlaced image data corresponding to even-numbered lines received before or after the interlaced image data corresponding to the odd-numbered lines in an image data buffer, and generating a progressive image by using the image data corresponding to the odd-numbered lines or the image data corresponding to the even-numbered lines that is stored in the image data buffer and corresponds to a line number of an image to be output;
when a value indicating a second mode is stored in the conversion mode setting register, the interpolation mode conversion section sequentially receiving image data corresponding to odd-numbered lines or sequentially receiving image data corresponding to even-numbered lines,
the interpolation mode conversion section performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;
after the even-numbered-line interpolation process, the interlace/progressive conversion section generating a progressive image by using image data corresponding to the odd-numbered lines and image data corresponding to the even-numbered lines generated by the even-numbered-line interpolation process; and
after the odd-numbered-line interpolation process, the interlace/progressive conversion section generating a progressive image by using image data corresponding to the even-numbered lines and image data corresponding to the odd-numbered lines generated by the odd-numbered-line interpolation process.

3. The image processing device as defined in claim 2,
the interpolation mode conversion section including:
an interpolation determination section that stores interlaced image data corresponding to odd-numbered lines and interlaced image data corresponding to even-numbered lines received before or after the interlaced image data corresponding to the odd-numbered lines in the image data buffer, and determines whether or not to interpolate target pixels in an interpolation target line by using pixel values of image data corresponding to the target line and having a predetermined positional relationship with the target pixels and pixel values of image data corresponding to lines preceding and subsequent to the interpolation target line; and
an interpolated value calculation section that calculates interpolated values of the target pixels by using the pixel values of the image data corresponding to the lines preceding and subsequent to the interpolation target line and having a predetermined positional relationship with the target pixels in the interpolation target line; and
the interpolation mode conversion section generating a progressive image by using the interpolated values or the pixel values of the image data corresponding to the target pixels as the target pixels based on a determination result for whether or not to interpolate the target pixels.

4. The image processing device as defined in claim 2,
the interpolation mode conversion section including:
an image data buffer read control section that sequentially reads image data corresponding to an nth line (n is an integer) and image data corresponding to an (n+1)th line from the image data buffer, and outputs the read image data to a first output line, a second output line and a third output line; and
an output line data generation section that generates progressive image data based on the input image data from the first output line, the second output line and the third output line into progressive image data, and outputs the progressive image data;
when the image data buffer read control section has read the image data corresponding to the nth line from the image data buffer, the image data buffer read control section outputting the read image data to the second output line and writing the read image data into a line buffer;
when the image data buffer read control section has read the image data corresponding to the (n+1)th line from the image data buffer, the image data buffer read control section outputting the read image data to the third output line, reading image data corresponding to an (n+2)th line from the image data buffer, outputting the read image data corresponding to the (n+2)th line to the second output line, and outputting image data corresponding to one line stored in the line buffer to the first output line; and
the output line data generation section outputting the image data from the second output line as the image data corresponding to the nth line, outputting the image data from the third output line as the image data corresponding to the (n+1)th line in a normal mode, performing an interpolation process based on the image data from the first output line and the second output line, and outputting interpolated data as the image data corresponding to the (n+1)th line in an interpolation mode.

5. The image processing device as defined in claim 4,
the image data buffer including a memory having a capacity smaller than a data volume corresponding to one display image; and
when image data corresponding to a predetermined even-numbered line or odd-numbered line is written into the image data buffer, the image data buffer read control section starting reading previously-written image data corresponding to an even-numbered line or an odd-numbered line of an image in the same frame as the image data corresponding to the predetermined even-numbered line or odd-numbered line.

6. An image processing device that receives interlaced image data and converts the interlaced image data into progressive image data, the image processing device comprising:
a conversion mode setting register in which mode information relating to a conversion format is set;
a normal mode conversion section, when a value indicating a first mode is stored in the conversion mode setting register, the normal mode conversion section storing interlaced image data corresponding to odd-numbered lines and interlaced image data corresponding to even-numbered lines received before or after the image data corresponding to the odd-numbered lines in an image data buffer, and generating a progressive image by using the image data corresponding to the odd-numbered lines or the image data corresponding to the even-numbered lines that is stored in the image data buffer and corresponds to a line number of an image to be output; and
a single-field mode conversion section, when a value indicating a second mode is stored in the conversion mode setting register, the single-field mode conversion section generating a progressive image by doubling the image data corresponding to the even-numbered lines or the image data corresponding to the odd-numbered lines.

7. A method of controlling an image processing device having an interlace/progressive conversion section that receives interlaced image data and converts the interlaced image data into progressive image data, the method comprising:
sequentially receiving image data corresponding to odd-numbered lines or sequentially receiving image data corresponding to even-numbered lines;
performing an even-numbered-line interpolation process that uses sequentially-received image data corresponding to first and second odd-numbered lines and generates image data corresponding to an even-numbered line between the first and second odd-numbered lines, or an odd-numbered-line interpolation process that uses sequentially-received image data corresponding to first and second even-numbered lines and generates image data corresponding to an odd-numbered line between the first and second even-numbered lines;
after the even-numbered-line interpolation process, generating a progressive image by using image data corresponding to odd-numbered lines, and image data corresponding to even-numbered lines generated by the even-numbered-line interpolation process; and
after the odd-numbered-line interpolation process, generating a progressive image by using image data corresponding to even-numbered lines and image data corresponding to odd-numbered lines generated by the odd-numbered-line interpolation process.

8. An image processing device having image data input terminals respectively provided for a plurality of input channels and an image data output terminal provided for at least one output channel, the image processing device comprising:
an input channel change control section that changes an output target input channel at a predetermined timing; and
an image data selection output section that receives image data corresponding to a first input channel up to image data corresponding to an nth input channel (n is an integer) from the image data input terminals in a predetermined cycle, and selects and outputs the image data from one of the image data input terminals corresponding to the output target input channel.

9. The image processing device as defined in claim 8,
the input channel change control section alternately assigning the input channels to be the output target input channel, and changing the output target input channel according to the assignment.

10. The image processing device as defined in claim 9, further comprising:
a selection condition setting register in which a condition relating to an image data selection ratio of the input channels is set,
the input channel change control section changing the output target input channel when a count value of a successive selection count of image data corresponding to each of the input channels has reached a successive selection count determined based on a value set in the selection condition setting register.

11. The image processing device as defined in claim 8, further comprising:
an output mode setting register in which mode information relating to an output format is set,
the input channel change control section not changing the output target input channel when a value indicating a first mode is stored in the output mode setting register.

12. An image processing device having image data input terminals respectively provided for a plurality of input channels and an image data output terminal provided for at least one output channel, the image processing device comprising:
an output mode setting register in which mode information relating to an output format is set;
an auto scan output section, when a value indicating a zeroth mode is stored in the output mode setting register, the auto scan output section performing an auto scan output process that sequentially changes an output target input channel and selects and outputs image data corresponding to the output target input channel from image data corresponding to the input channels; and
a fixed channel output section, when a value indicating a first mode is stored in the output mode setting register, the fixed channel output section performing a fixed channel output process that outputs image data corresponding to a fixed input channel without changing the output target input channel.

13. The image processing device as defined in claim 10, further comprising:
a reduced image generation section that generates a first reduced image to an nth reduced image in parallel (n is an integer) based on image data input through one of the image data input terminals corresponding to a first input channel up to one of the image data input terminals corresponding to an nth input channel, and generates a reduced image based on the image data input through the input channels,
when a value indicating a second mode is stored in the output mode setting register, the image processing device sequentially outputting the first reduced image to the nth reduced image generated corresponding to image data input through the image data input terminals of the input channels.

14. The image processing device as defined in claim 12, further comprising:
a reduced image generation section that generates a first reduced image to an nth reduced image in parallel (n is an integer) based on image data input through one of the image data input terminals corresponding to a first input channel up to one of the image data input terminals corresponding to an nth input channel, and generates a reduced image based on the image data input through the input channels,
when a value indicating a second mode is stored in the output mode setting register, the image processing device sequentially outputting the first reduced image to the nth reduced image generated corresponding to image data input through the image data input terminals of the input channels.

15. The image processing device as defined in claim 10, further comprising:
a reduced image generation section that generates a first reduced image to an nth reduced image in parallel (n is an integer) based on image data input through one of the image data input terminals corresponding to a first input channel up to one of the image data input terminals corresponding to an nth input channel, and generates a reduced image based on the image data input through the input channels; and
a merged image generation section that generates a merged image by merging the first reduced image to the nth reduced image,
when a value indicating a third mode is stored in the output mode setting register, the image processing device outputting the merged image generated by the merged image generation section.

16. The image processing device as defined in claim 12, further comprising:
a reduced image generation section that generates a first reduced image to an nth reduced image in parallel (n is an integer) based on image data input through one of the image data input terminals corresponding to a first input channel up to one of the image data input terminals corresponding to an nth input channel, and generates a reduced image based on the image data input through the input channels; and
a merged image generation section that generates a merged image by merging the first reduced image to the nth reduced image,
when a value indicating a third mode is stored in the output mode setting register, the image processing device outputting the merged image generated by the merged image generation section.

17. A data recording device comprising:
the image processing device as defined in claim 8, image data from a plurality of imaging sections being input to the image processing device through image data input terminals respectively provided for a plurality of input channels;
a write section that writes an output from the image processing device into a first storage section;
an image data record event detection section that detects whether or not a predetermined image data record event has occurred; and
a write section that reads image data stored in the first storage section and writes the read image data into a nonvolatile second storage section when occurrence of the predetermined image data record event has been detected.

18. A data recording device comprising:
the image processing device as defined in claim 12, image data from a plurality of imaging sections being input to the image processing device through image data input terminals respectively provided for a plurality of input channels;
a write section that writes an output from the image processing device into a first storage section;
an image data record event detection section that detects whether or not a predetermined image data record event has occurred; and
a write section that reads image data stored in the first storage section and writes the read image data into a nonvolatile second storage section when occurrence of the predetermined image data record event has been detected.

19. A method of controlling an image processing device having image data input terminals respectively provided for a plurality of input channels and an image data output terminal provided for at least one output channel, the method comprising:
changing an output target input channel at a predetermined timing; and
receiving image data corresponding to a first input channel up to image data corresponding to an nth input channel (n is an integer) from the image data input terminals in a predetermined cycle, selecting and outputting the image data from one of the image data input terminals corresponding to the output target input channel.

20. A method of controlling an image processing device having image data input terminals respectively provided for a plurality of input channels and an image data output terminal provided for at least one output channel, the method comprising:
setting mode information relating to an output format in an output mode setting register;
when a value indicating a zeroth mode is stored in the output mode setting register, performing an auto scan output process that sequentially changes an output target input channel and selects and outputs image data corresponding to the output target input channel from image data corresponding to the input channels; and
when a value indicating a first mode is stored in the output mode setting register, performing a fixed channel output process that outputs image data corresponding to a fixed input channel without changing the output target input channel.
